(19) United States
(12) Patent Application Publication
(10) Pub. No.: US 2015/0131491 A1
(43) Pub. Date: May 14, 2015

(54) Tracking

(71) Applicant: Broadcom Corporation, Irvine, CA (US)

(72) Inventors: Kari Juhani RIKKINEN, Ii (FI); Wei LI, Oulu (FI); Jorma Olavi LILLEBERG, Oulu (FI)

(21) Appl. No.: 14/328,820

(22) Filed: Jul. 11, 2014

(30) Foreign Application Priority Data
Jul. 12, 2013 (GB) 1312553.9

(51) Int. Cl. H04L 5/14

(52) U.S. Cl. CPC H04L 5/1461; H04L 5/143
USPC 370/278

(57) ABSTRACT

The present invention relates to methods, apparatuses and computer program products for use in bi-directional channel tracking. The invention includes allocating, at a first network entity, a sub-carrier in a frequency domain for transmitting a tone to a second network entity, prohibiting, at the first network entity, receiving signals on the sub-carrier allocated for transmitting the tone, estimating, at the first network entity, a channel of residual self-interference based on the transmitted tone.

### TECHNICAL FIELD

The present invention relates to tracking. In particular, but not exclusively, the present invention relates to methods, apparatuses and computer program products for bi-directional channel tracking.

### BACKGROUND

When a transceiver is transmitting and receiving on the same frequency bands and at the same time, it operates in full-duplex mode. Full-duplex transceivers are not widely utilized in traditional wireless communication systems because the strong self-interference may saturate it's receive radio frequency (RF) chain so that the desired signal cannot be restored.

Recently, it has been proposed in some documents (see [1] to [10] referenced below) to suppress the self-interference by an added RF cancellation circuit. These published results showed that the self-interference could be reduced by up to 30 dB after using their designed analogue RF canceller. According to the latest full-duplex studies that the applicant is involved in, the self-interference could be reduced by around 45˜70 dB before baseband processing in 20 MHz bandwidth by jointly implementing antenna isolation and RF cancellation techniques. These promising numbers indicate that full-duplex communications become closer to practical implementation, at least for local area communications that prefer a short communication range and low transmission power.

In contention-based full-duplex communication networks, a node usually transmits data when it has arrival traffic (the acknowledgement is regarded as special traffic). Because of the randomness of the arrival traffic, a full-duplex node is not always transmitting signals so that it only switches to the full-duplex mode when it is necessary. As a result, the node must estimate the self-interference channel to initialize its self- interference cancellers when it is going to start a full-duplex communications. As the transmissions are bi-directional, three channel estimates are required for each transmission to setup the RF canceller, setup the digital baseband canceller and detect the desired signal correspondingly.

There are two reasons why a digital baseband canceller is still employed: The first reason is that RF cancellation is in general non-perfect. According to our current investigations, self-interference can be reduced by up to 70 dB by employing certain antenna isolation and RF cancellation techniques. However, the residual self-interference may still be relatively stronger than the desired signal in some cases.

Considering an example where there are two nodes with transmit powers both equal to 20 dBm, the operating carrier frequency is 2.4 GHz and the signal bandwidth is 20 MHz. In this setup,
a. the power of the residual self-interference is about −50 dBm after 70 dB self-interference cancellation before baseband processing;
b. the power of the desired signal is about −44 to −58 dBm for the communication range 10 to 50 meters if applying a pico-cell path-loss model (not considering shadow fading);
c. the effective receiver noise power is about −90 dBm if the noise spectrum density is −174 dBm/Hz and the receiver noise figure is 13 dB.

In view of the above, there may be a case where, for example, the residual self-interference may be much stronger than the receiver noise and sometimes even stronger than the desired signal.

The second reason is that the self-interference in full-duplex communications also experiences the time-varying environment. In general, the self-interference is mainly from near field signal coupling and far field signal reflection. In a relatively long period, e.g. a few milliseconds, near field signal coupling is somewhat stationary and has the dominant power. Therefore, the RF canceller can suppress the near field coupling so that the RF circuit can work in a linear working range. However, the far field signal reflection may not be as stationary as the near field coupling. Therefore, a digital baseband canceller can be used to further suppress the self-interference from the far field reflection.

Consequently, how to track the channel of the residual self-interference in the time-varying environment is one critical issue for full-duplex communications to be solved.

There are several documents about full-duplex transceiver design but most of them are focused on designing full-duplex RF front-ends and don't explicitly describe how baseband channel tracking is carried out.

However, in document [1], section 3.4 discusses residual self-interference channel estimation at the digital baseband (after analogue RF cancellation). In this experimental design, known training symbols in front of a transmitted OFDM (orthogonal frequency division multiplexing) packet are used. In particular, a periodic and interference-free period for channel estimation is used. In section 7, ‘in-packet channel estimation’ for more dynamic environments is also mentioned.

In document [5] section 3.3, two concepts, ‘dirty estimation’ and ‘clean estimation’, are introduced. The authors concluded that for initializing the RF canceller, ‘clean estimation’ is preferred. There is a simple handshake example provided in document [5], which is shown in FIG. 1.

To understand the principle of FIG. 1, it is noted that the depicted transmission blocks such as ‘DATA’ and ‘ACK’ are representing real signal frames having complete physical layer structure as well as the corresponding carried Medium Access Control (MAC) layer content ‘DATA’ or ‘ACK’. In order to establish full-duplex transmission, the sources AP (access point) and the M1 (mobile equipment) must work in the half-duplex mode. Firstly, the AP sends its first DATA 11 to the node M1 and informs a full-duplex mode request. The M1 accepts the request and sends ACK 12 to the AP. At the same time, the M1 can train its RF canceller when sending the ACK. After receiving the ACK 12 from the M1, the AP sends another ACK 13 to complete the handshake with the M1 and at the same time trains its RF canceller when sending the ACK. After that, both RF cancellers are configured and full-duplex transmission can be started.

In document [5], the authors relied on the RF cancellation. However, it is possible to use digital baseband cancellation together with the scheme proposed in document [5].

During the full-duplex transmission period in FIG. 1, the AP and the M1 are sending data frames having common conventional 802.11 physical structure (we consider OFDM PHY specification of 802.11 standard). Excluding the preamble header in front of the frames, they consists of many OFDM symbols having data tones (or subcarriers) 21, 22 and pilot tones (or subcarriers) 23, 24, as shown in FIG. 2. Because of the full-duplex transmission, the pilot and data tones transmitted by the AP and node M1 are actually overlapped with each other in both the frequency and time domains. In this case, by treating all other received signals as noise, both the AP and the M1 can still exploit the whole self-transmitted frame as a training frame to estimate the self-interference channel, then perform digital baseband cancellation.

However, this method cannot obtain satisfactory performance, which will be shown below by numerical analysis.

Further, channel tracking methods for conventional multi-antenna communication systems are known. However, in these methods, similar concepts are utilized in half-duplex and full-duplex wireless systems, and thus differ from the proposal according to the present invention.

### REFERENCES

[1] Mayank Jain, Jung Il Choi, Tae Min Kim, et. al., Practical, Real-time, Full Duplex Wireless, MobiCom 2011.
[2] Jung Il Choi, Mayank Jain, Kannan Srinivasan, et. al., Achieving Single Channel, Full Duplex Wireless Communication, Mobicom 2010.
[3] Melissa Duarte and Ashutosh Sabharwal, Full-duplex wireless communications using off-the-shelf radios: Feasibility and first results, In Forty-Fourth Asilomar Conference on Signals, Systems, and Components, 2010.
[4] Evan Everett, Melissa Duarte, Chris Dick and Ashutosh Sabharwal, Empowering Full-Duplex Wireless Communication by Exploiting Directional Diversity, Asilomar 2011.
[5] Achaleshwar Sahai, Gaurav Patel and Ashutosh Sabharwal, Pushing the limits of Full-duplex: Design and Real-time Implementation, Rice University technical report TREE 1104.
[6] Radunovic B, Gunawardena D, Key P, Proutiere A, Rethinking Indoor Wireless Mesh Design: Low Power, Low Frequency, Full-Duplex.
[7] Byungjin Chun, Eui-rim Jeong, Jingon Joung, et. al., Pre-nulling for self-interference suppression in full-duplex relays.
[8] Mohammad A. Khojastepour and Karthik Sundaresan, The case for antenna cancellation for scalable full-duplex wireless communications.
[9] Andrew Thangaraj, Radha Krishna Ganti and Srikrishna Bhashyam, Self-interference cancellation models for full-duplex wireless communications.
[10] Evan Everett, Debashis Dash, Chris Dick and Ashutosh Sabharwal, Self-interference cancellation in multi-hop full-duplex networks via structured signaling.

In view of the above, it is an object of certain embodiments of the present invention to provide a method to estimate the channels in contention-based full-duplex communications. It is another object of certain embodiments of the present invention to provide an adaptive switching mechanism to change between channel tracking modes.

### BRIEF DESCRIPTION OF THE DRAWINGS

FIG. 1 is a diagram illustrating one example of a timeline of packets sent between two nodes according to a handshake mechanism.

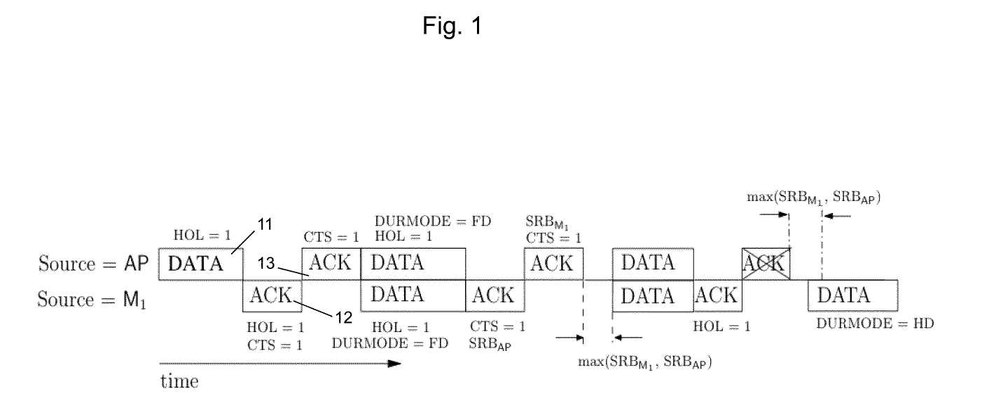

FIG. 2 is a diagram illustrating a pilot and data sub-carrier design.

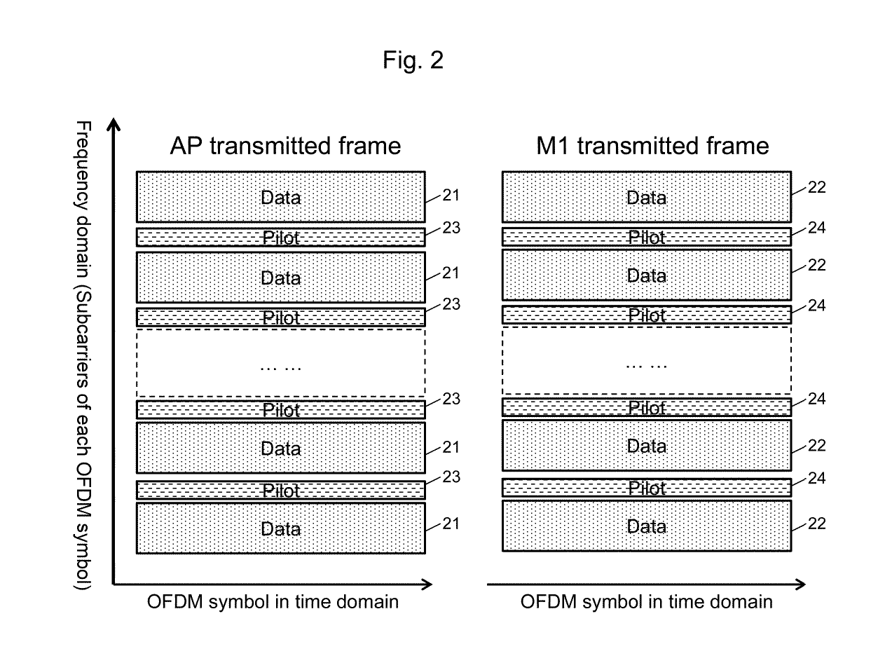

FIG. 3 is a diagram illustrating an example of a pilot and data sub-carrier design according to certain embodiments of the present invention.

FIG. 4 is a diagram illustrating another example of a pilot and data sub-carrier design according to certain embodiments of the present invention.

FIG. 5 is a diagram illustrating another pilot and data tone design according to certain embodiments of the present invention.

FIG. 6 is a diagram illustrating an example performance comparison between alternative schemes.

FIG. 7 is a diagram illustrating switching point computation in a case where two nodes start sending at the same time.

FIG. 8 is a diagram illustrating switching point computation in a case where two nodes complete sending at the same time.

FIG. 9 is a flowchart illustrating an example of a method according to certain embodiments of the present invention.

FIG. 10 is a flowchart illustrating an example of another method according to certain embodiments of the present invention.

FIG. 11 is a block diagram illustrating an example of an apparatus according to certain embodiments of the present invention.

### DETAILED DESCRIPTION

According to some example aspects of the present invention, there are provided methods, apparatuses and computer program products for bi-directional channel tracking schemes in contention based full-duplex communications.

Various aspects of example embodiments of the present invention are set out in the appended claims.

According to a first aspect of the present invention, there is provided a method for use in bi-directional channel tracking, the method comprising: allocating, at a first network entity, a sub-carrier in a frequency domain for transmitting a tone to another a second network entity, prohibiting, at the first network entity, receiving signals on the sub-carrier allocated for transmitting the tone, and estimating, at the first network entity, a channel of residual self-interference based on the transmitted tone.

According to a second aspect of the present invention, there is provided apparatus for use in bi-directional channel tracking in a first network entity, the apparatus comprising a processing system configured to cause the apparatus at least to: allocate, at a first network entity, a sub-carrier in a frequency domain for transmitting a tone to a second network entity, prohibit, at the first network entity, receiving signals on the sub-carrier allocated for transmitting the tone, and estimate, at the first network entity, a channel of residual self-interference based on the transmitted tone.

According to embodiments of the present invention, there is provided apparatus comprising: means for allocating, at a first network entity, a sub-carrier in a frequency domain for transmitting a tone to a second network entity, means for prohibiting, at the first network entity, receiving signals on the sub-carrier allocated for transmitting the tone, and means for estimating, at the first network entity, a channel of residual self-interference based on the transmitted tone.

According to another example aspect of the present invention, there is provided a computer program product comprising computer-executable computer program code which, when the program is run on a computer (e.g. a computer of an apparatus according to any one of the aforementioned apparatus-related example aspects of the present invention), is arranged to cause the computer to carry out the method according to any one of the aforementioned method-related example aspects of the present invention.

Such a computer program product may comprise or be embodied as a (tangible) computer-readable (storage) medium or the like on which the computer-executable computer program code is stored, and/or the program may be directly loadable into an internal memory of the computer or a processor thereof.

Further features and advantages of the invention will become apparent from the following description of preferred embodiments of the invention, given by way of example only, which is made with reference to the accompanying drawings.

Example aspects of the present invention will be described herein below. More specifically, example aspects of the present are described hereinafter with reference to particular non-limiting examples and embodiments of the present invention. A person skilled in the art will appreciate that the invention is by no means limited to these examples, and may be more broadly applied.

It is to be noted that the following description of some embodiments of the present invention mainly refers to specifications being used as non-limiting examples for certain example network configurations and deployments. Namely, some embodiments of the invention are mainly described in relation to IEEE 802.11 specifications (wireless local area network, WLAN) being used as non-limiting examples for certain example network configurations and deployments. As such, the description of example embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein, e.g. any 3GPP cellular system, e.g. LTE (long term evolution) or LTE-Advanced or 3G or the like. Further, some embodiments of the invention may also be applicable to techniques according to WiMAX (Worldwide Interoperability for Microwave Access).

According to certain embodiments of the present invention, a bi-directional channel tracking method is developed to estimate the three channels in the full-duplex mode.

It is noted that in view of the document [1] described above, some embodiments of the present invention may be regarded as one ‘in-packet channel estimation’, for example. In some embodiments of the invention, more training resources to track the channels may be used. It may be considered to switch adaptively the bi-directional channel tracking mode on and off when the frame lengths of the bi-directional transmission are different. Example aspects are:
1. providing a novel and inventive channel tracking method.
2. providing an adaptive switching mechanism to change between the two channel tracking modes and the corresponding handshake behaviors.

For example, in order to improve the performance, two designs for bi-directional channel tracking are proposed. In particular, focus is made on channel estimation during the full-duplex transmission period, where the RF cancellers have been configured properly.

In some embodiments of the invention, two orthogonal pilot tones are allocated in the frequency domain for estimating the channels of the bi-directional transmissions.

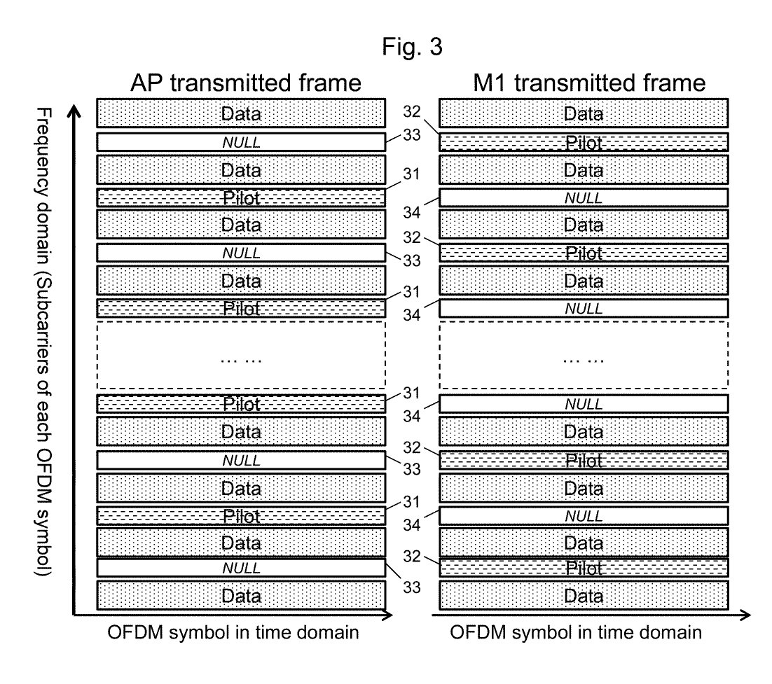

As shown in FIG. 3, the AP's pilot tones 31 and the M1's pilot tones 32 are using different frequency sub-carriers. Moreover, the M1 doesn't transmit any signal on the sub- carriers 34 allocated as the AP's pilot tones, while the AP also doesn't transmit any signal on the sub-carriers 33 allocated as the M1's pilot tones. By using the orthogonal allocation, both the AP and the M1 can use their self-transmitted pilot tones to estimate the channel of the residual self-interference. After obtaining the channel of the residual self-interference, they can suppress the residual self-interference by the digital baseband canceller. Also, they can use the counterpart's pilot tones to estimate the channel of the desired signal and demodulate the desired signal.

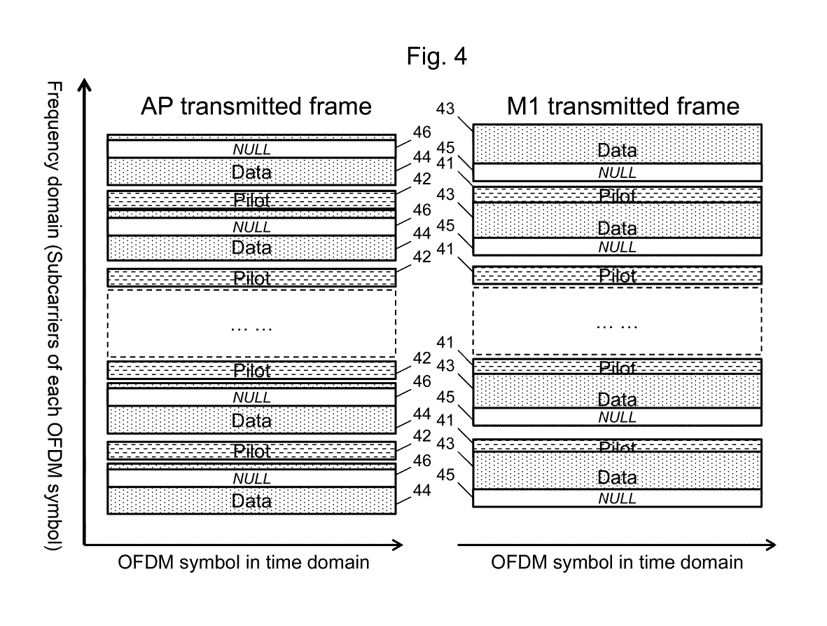

Besides orthogonal pilot tone allocation, there is another design shown in FIG. 4. In some embodiments of the invention, the AP and the M1 still use the same sub-carriers as their pilot tones, i.e. M1 uses sub-carrier 41 for its pilot tone and AP uses sub-carrier 42 for its pilot tone, as shown in FIG. 4. However, a few orthogonal and dedicated data tones are allocated for estimating the channel of the residual self-interference during the full-duplex transmission period. As shown in FIG. 4, M1 uses sub-carrier 43 for its dedicated data tone and AP uses sub-carrier 44 for its dedicated data tone. At the sub-carriers 45 used as the AP's dedicated data tones 44, the M1 doesn't transmit any signal. At the sub-carriers 46 used as the M1's dedicated data tones 43, the AP doesn't transmit any signal either. Because the AP knows its transmitted data signals at the dedicated data tones, it can estimate the channel of the residual self-interference via these dedicated data tones for digital baseband cancellation (and vice versa for the M1).

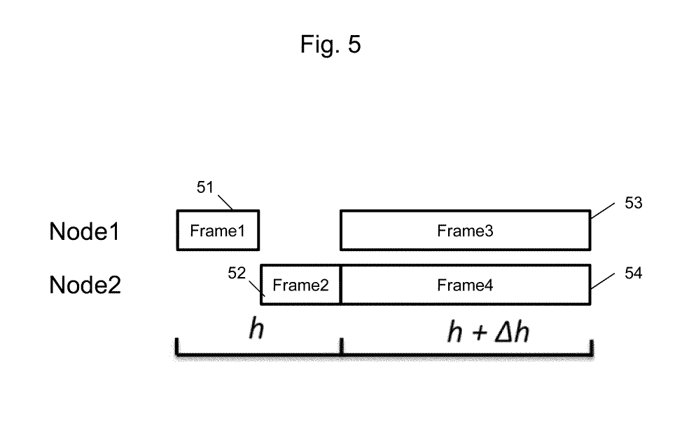

As an example, a simple simulation is made to compare the performance of the alternative designs. In this simulation, the simplified MAC handshake mechanism with a simple model of the time-varying effect is considered, as shown in FIG. 5. During the period of sending Framel 51 and Frame2 52, the channel of the self-interference is assumed to be h constantly. During the period of sending Frame3 53 and Frame4 54, the channel is changed from h to h+Δh because of the time-varying environment. This is a simple model of the time-varying effect of the channel which is just used for verifying the improvement of the new schemes. In this simulation, Δh is modeled as a Gaussian noise with a certain value of variance.

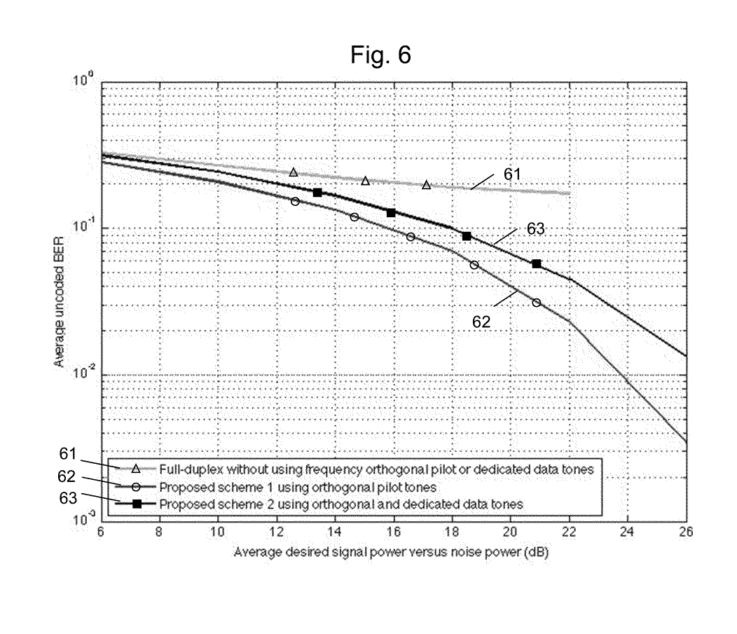

The result is provided as follows where the variance of Δh is set as −50 dBm. There are other parameters in this simulation. For example, the transmission powers of both nodes are 20 dBm, the modulation scheme is 64 QAM, the equivalent receiver noise is −89 dBm for 20 MHz bandwidth, and so on. From this comparison, it is shown in FIG. 6 that both designs show better performance than that without using the new designs. In FIG. 6, curve 61 shows the result with respect to full duplex without using frequency orthogonal pilot or dedicated data tones, curve 62 shows the result with respect to some embodiments of the present invention using orthogonal pilot tones and curve 63 shows the result with respect to some embodiments of the present invention using orthogonal and dedicated data tones.

As shown in FIG. 6, using orthogonal pilot tones for both channel estimation of the self-interference and the desired signal, it is possible to achieve better performance. Thus, from a performance viewpoint, this may be the best choice although it may require changing the layout of putting the training resource into the physical frame.

As derivable from FIG. 6, using orthogonal and dedicated data tone for channel estimation of self-interference gives a slightly worse performance, but it doesn't require changing the basic layout of the pilot tones and the number of the dedicated data tones for the self-interference estimate may be adaptively changed depending on the environment. From this aspect, it may be easier to build a full-duplex system on top of an existing system, e.g. 802.11 systems.

In the new designs described above, fewer radio resources can be used for data transmission compared with reusing conventional design. For example, some embodiments of the invention may improve error rate performance, in some cases especially when the Signal-to-Noise Ratio (SNR) is increased, as shown in FIG. 6. This may finally increase the valid throughput because more frames can be transmitted successfully.

However, it is to be noted that the diagram shown in FIG. 6 is only an illustrative example of the performance comparison and should not be interpreted to limit the present invention.

When designing the channel tracking method for full-duplex communications, there is another thing to be considered. In FIG. 5, it is implicitly assumed that the two nodes have the same length frame to be sent during full-duplex transmission period. However, Frame3 53 and Frame4 54 may have different lengths. Considering this simple fact, an adaptive channel tracking scheme can be utilized in order to further improve the transmission efficiency as the proposed bi-directional channel tracking method consumes more resources. For instance, in 802.11 OFDM PHY specification, there are 4 pilot tones and 48 data tones. To support the full-duplex transmission, the considered channel tracking schemes require either 8 pilot tones or 4 pilot tones plus 4 (or less) dedicated data tones. The ratio of the resource for the channel tracking over the overall resource is reduced from 4/52 to 8/52. If there is no adaptive switch between the two channel tracking schemes, around 7/0-8% of resources may be wasted when Frame3 and Frame4 have different lengths.

In some embodiments of the invention, the two nodes will exchange the lengths (and/or data associated with the lengths) of their incoming full-duplex transmissions so that a switching point can be found to enable or disable the bi-directional channel tracking. Still using FIG. 5 as an example, the basic procedure of the adaptive switch between the two channel tracking schemes can be explained as follows.

In some embodiments of the invention, Node 1 informs Node 2 about its frame length of the incoming transmission via Framel. Node 2 may also inform Node 1 about its frame length of the incoming transmission via Frame2.

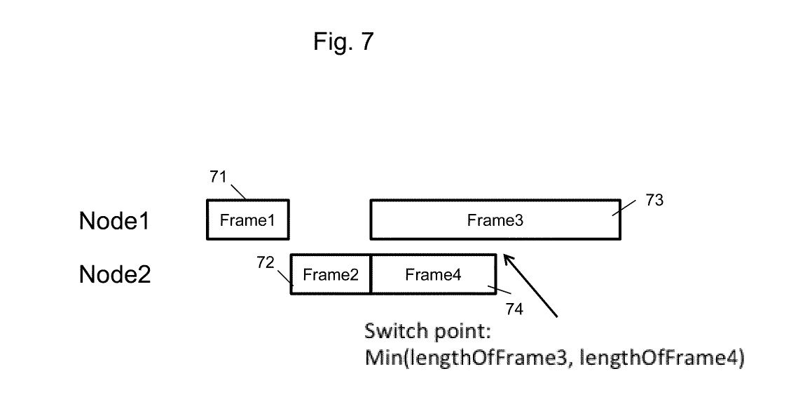

After knowing both frame lengths, the switch point can be determined if a fixed full-duplex transmission method is previously agreed by the two nodes. In an example shown in FIG. 7, Frame3 73 and Frame4 74 have different lengths, namely, Frame3 73 is longer than Frame4 74. As described above, Node 1 may inform Node 2 about its frame length of the incoming transmission via Framel 71, and Node 2 may also inform Node 1 about its frame length of the incoming transmission via Frame2 72. Then, if both nodes start sending data right after Frame2 72, the switching point can be computed as illustrated in FIG. 7. That is, the switching point is at the end of the shorter frame, e.g. at the end of frame4 74 in the example shown in FIG. 7, so that the timing of the switching point is calculated as minimum of (length_of_frame 3, length_of_frame 4).

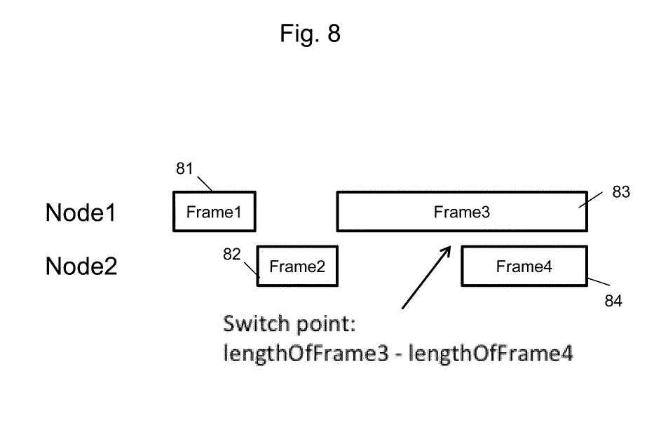

In another example, as shown in FIG. 8, Frame3 83 and Frame4 84 also have different lengths, namely, Frame3 83 is shorter than Frame4 84. In a similar manner as described above, Node 1 may inform Node 2 about its frame length of the incoming transmission via Framel 81, and Node 2 may also inform Node 1 about its frame length of the incoming transmission via Frame2 82. In some embodiments of the invention, if both nodes want to complete data sending at the same time, the switching point can be computed as illustrated in FIG. 8. That is, the switching point is at the beginning of the shorter frame, i.e. at the beginning of frame4 84 in the example shown in FIG. 8, so that the timing of the switching point is calculated as (length_of_frame_3-length_of_frame 4).

It is an advantage of certain embodiments according to the present invention that the developed channel tracking method enables dynamic environment tracking in full-duplex communications, especially for the self-interference channel.

Further, in some embodiments of the invention, signaling may enable the adaptive switching amongst different operation modes, which improves the transmission efficiency.

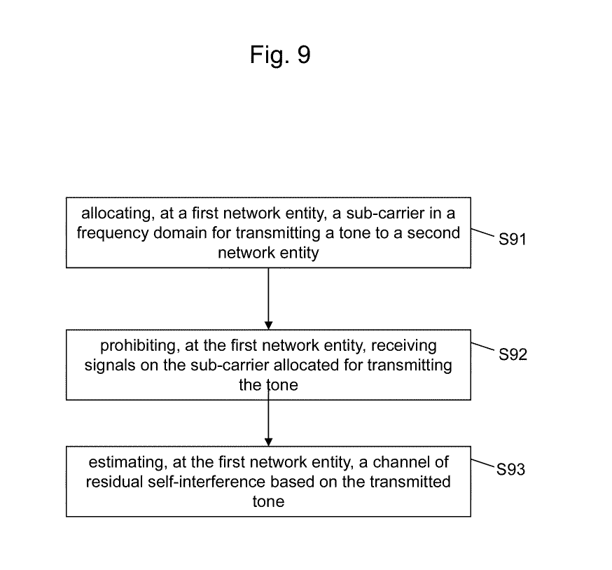

FIG. 9 shows an example flowchart of an example for a method according to certain embodiments of the present invention. That is, as shown in FIG. 9, this method for use in a first network entity or part of the first network entity comprises, in a step S91, allocating, at the first network entity, a sub-carrier in a frequency domain for transmitting a tone to a second network entity, in a step S92, prohibiting, at the first network entity, receiving signals on the sub-carrier allocated for transmitting the tone, and, in a step S93, estimating, at the network entity, a channel of residual self-interference based on the transmitted tone.

According to certain aspects of the present invention, the method further comprises suppressing the residual self-interference using a digital baseband canceller based on the estimated channel of the residual self-interference.

According to certain aspects of the present invention, the tone is a pilot tone transmitted to the second network entity.

According to certain aspects of the present invention, the method further comprises receiving a pilot tone transmitted from the second network entity, the transmitted pilot tone and the received pilot tone being orthogonal to each other, estimating, at the first network entity, a channel of a desired signal based on the received pilot tone, and demodulating the desired signal.

According to certain aspects of the present invention, the tone is a dedicated data tone transmitted to the second network entity.

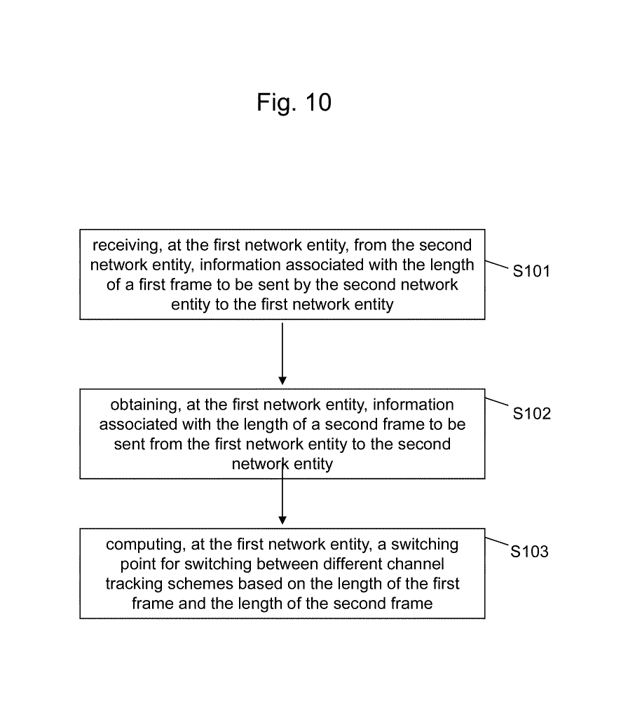

FIG. 10 shows an example flowchart of another example for a method according to certain embodiments of the present invention. That is, as shown in FIG. 10, this method for use in a network entity or part of the network entity comprises, in a step S101, receiving, at the first network entity, from a second network entity information on the length of a first frame to be sent by the second network entity to the first network entity, obtaining, at the first network entity, information on the length of a second frame to be sent from the first network entity to the second network entity in a step S102, and computing, at the first network entity, a switching point for switching between different channel tracking schemes based on the length of the first frame and the length of the second frame in a step S103.

According to certain aspects of the present invention, if the first network entity starts sending the second frame at the same time as the second network entity starts sending the first frame, the switching point is computed based on the minimum of the length of the first frame and the length of the second frame.

According to certain aspects of the present invention, if the first network entity completes transmission of the second frame at the same time as the second network entity completes transmission of the first frame, the switching point is computed by subtracting the shorter one of the first and second frames from the longer one of the first and second frames.

It is noted that the above described methods illustrated in FIGS. 9 and 10 may be combined. The different patterns of allocating training resources should be known by both two nodes, i.e. the AP and the terminal M1. After exchanging the lengths of the two frames in the incoming two-way transmission phase, one node should indicate the training resource pattern by explicit signaling. However, the present invention is not limited to such an order of exchanging the lengths and signaling the patterns. That is, for example, one node may first indicate the training resource pattern by explicit signaling and the nodes exchange the lengths of the two frames in the incoming two-way transmission phase. Further, it is noted that exchanging the lengths and signaling the patterns may also be performed simultaneously.

According to certain aspects of the present invention, the method further comprises causing transmission, from the first network entity to the second network entity, of information indicating a pattern of allocation.

According to certain aspects of the present invention, the method further comprises causing reception, at the first network entity from the second network entity, of information indicating a pattern of allocation, and selecting the pattern according to the information received from the second network entity.

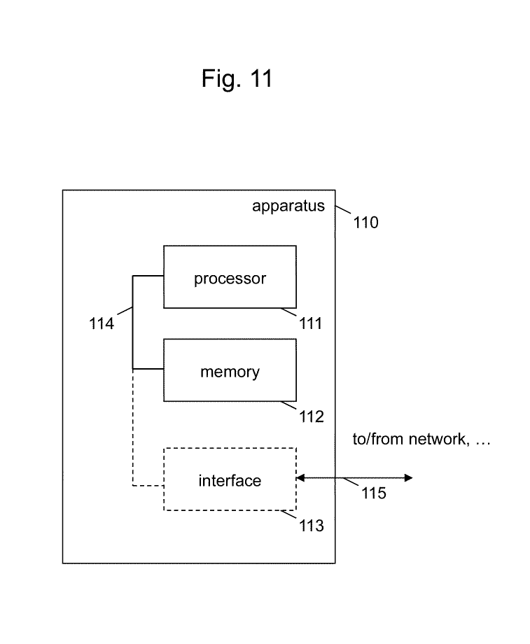

FIG. 11 shows a principle configuration of an example for an apparatus according to certain embodiments of the present invention. The apparatus 110, e.g. a first network entity, comprises a processing system and/or at least one processor 111 and at least one memory 112 including computer program code, which are connected by a bus 114 or the like. As indicated with a dashed line in FIG. 11, an interface 113 may be connected to the bus 114 or the like, which may enable communication e.g. to/from another network entity, or the like. The processing system and/or the at least one memory and the computer program code are arranged to, with the at least one processor, cause the first network entity at least to perform allocating a sub-carrier in a frequency domain for transmitting a tone to a second network entity, prohibiting receiving signals on the sub-carrier allocated for transmitting the tone, and estimating a channel of residual self-interference based on the transmitted tone.

Further, the processing system and/or the at least one memory and the computer program code are arranged to, with the at least one processor, cause a first network entity at least to perform receiving, at the first network entity, from a second network entity information on length of a first frame to be sent by the second network entity to the first network entity, obtaining, at the first network entity, information on length of a second frame to be sent from the first network entity to the second network entity, and computing, at the first network entity, a switching point for switching between different channel tracking schemes based on the length of the first frame and the length of the second frame.

For further functions of the apparatus according to further example embodiments of the present invention, reference is made to the above description of methods according to certain embodiments of the present invention, as described in connection with FIGS. 9 and 10.

One option for implementing this example for an apparatus according to certain versions of the present disclosure would be a component in a handset such as a user equipment (UE) according to IEEE 802.11, 3G or LTE/LTE-A or any future developed technology, for example. For example, the user equipment may be a mobile phone, a personal digital assistant (PDA), a laptop computer, a tablet computer, or the like.

Another option for implementing this example for an apparatus according to certain versions of the present disclosure would be a component in a base station, e.g. NodeB (NB) or evolved NodeB (eNB), WLAN (wireless local area network) station, router or access point according to IEEE 802.11, 3G or LTE/LTE-A or any future developed technology.

In the foregoing example description of the apparatus, i.e. the user equipment (or part of the user equipment), base station (or part of the base station), access point (or part of the access point), only the units that are relevant for understanding the principles of the invention have been described using functional blocks. The apparatus may comprise further units that are necessary for its respective operation as a base station or part of a base station, respectively. However, a description of these units is omitted in this specification. The arrangement of the functional blocks of the apparatus should not be construed to limit the invention, and the functions may be performed by one block or further split into sub-blocks.

According to example embodiments of the present invention, a system may comprise any conceivable combination of the thus depicted devices/apparatuses and other network elements, which are arranged to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any procedural step or functionality is suitable to be implemented as software or by hardware without changing the ideas of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic),TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package (SIP), or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for use in bi-directional channel tracking, the method comprising: allocating, at a first network entity, a sub-carrier in a frequency domain for transmitting a tone to a second network entity;
prohibiting, at the first network entity, receiving signals on the sub-carrier allocated for transmitting the tone; and
estimating, at the first network entity, a channel of residual self-interference based on the transmitted tone.

2. The method according to claim 1, comprising suppressing the residual self-interference using a digital baseband canceller based on the estimated channel of the residual self-interference.

3. The method according to claim 1, wherein the tone comprises a pilot tone transmitted to the second network entity or a dedicated data tone transmitted to the second network entity.

4. The method according to claim 2, comprising:
causing reception of a pilot tone transmitted from the second network entity, the transmitted pilot tone and the received pilot tone being orthogonal to each other;
estimating, at the first network entity, a channel of a desired signal based on the received pilot tone; and
demodulating the desired signal.

5. (canceled)

6. The method according to claim 1, comprising:
causing reception, at the first network entity, from the second network entity, information associated with the length of a first frame to be sent by the second network entity to the first network entity;
obtaining, at the first network entity, information associated with the length of a second frame to be sent from the first network entity to the second network entity; and
computing, at the first network entity, a switching point for switching between different channel tracking schemes based on the length of the first frame and the length of the second frame.

7. The method according to claim 6, wherein, if the first network entity starts sending the second frame at the same time as the second network entity starts sending the first frame, the switching point is computed based on the minimum of the length of the first frame and the length of the second frame.

8. The method according to claim 6, wherein, if the first network entity completes transmission of the second frame at the same time as the second network entity completes transmission of the first frame, the switching point is computed by subtracting the shorter one of the first and second frames from the longer one of the first and second frames.

9. The method according to claim 1, comprising causing transmission, from the first network entity to the second network entity, of information indicating a pattern of allocation.

10. The method according to claim 1, comprising:
causing reception, at the first network entity from the second network entity, of information indicating a pattern of allocation; and
selecting the pattern according to the information received from the second network entity.

11. An apparatus for use in bi-directional channel tracking in a first network entity, the apparatus comprising a processing system including at least one processor and at least one memory storing computer program code, wherein the processing system is configured to cause the apparatus at least to:
allocate, at a first network entity, a sub-carrier in a frequency domain for transmitting a tone to a second network entity;
prohibit, at the first network entity, receiving signals on the sub-carrier allocated for transmitting the tone; and
estimate, at the first network entity, a channel of residual self-interference based on the transmitted tone.

12. The apparatus according to claim 11, the processing system being configured to cause the apparatus to suppress the residual self-interference using a digital baseband canceller based on the estimated channel of the residual self-interference.

13. The apparatus according to claim 11, wherein the tone comprises a pilot tone transmitted to the second network entity.

14. The apparatus according to claim 12, the processing system being configured to cause the apparatus to:
cause reception of a pilot tone transmitted from the second network entity, the transmitted pilot tone and the received pilot tone being orthogonal to each other;
estimate, at the first network entity, a channel of a desired signal based on the received pilot tone; and
demodulate the desired signal.

15. The apparatus according to claim 11, wherein the tone comprises a dedicated data tone transmitted to the second network entity.

16. The apparatus according to claim 11, the processing system being configured to cause the apparatus to:
cause reception, at the first network entity, from the second network entity, information associated with the length of a first frame to be sent by the second network entity to the first network entity;
obtain, at the first network entity, information associated with the length of a second frame to be sent from the first network entity to the second network entity; and
compute, at the first network entity, a switching point for switching between different channel tracking schemes based on the length of the first frame and the length of the second frame.

17. The apparatus according to claim 16, wherein, if the first network entity starts sending the second frame at the same time as the second network entity starts sending the first frame, the switching point is computed based on the minimum of the length of the first frame and the length of the second frame.

18. The apparatus according to claim 16, wherein, if the first network entity completes transmission of the second frame at the same time as the second network entity completes transmission of the first frame, the switching point is computed by subtracting the shorter one of the first and second frames from the longer one of the first and second frames.

19. The apparatus according to claim 11, the processing system being configured to cause the apparatus to to cause transmission, from the first network entity to the second network entity, of information indicating a pattern of allocation.

20. The apparatus according to claim 11, the processing system being configured to cause the apparatus to:
cause reception, at the first network entity from the second network entity, of information indicating a pattern of allocation; and
select the pattern according to the information received from the second network entity.

21-23. (canceled)

25. A method for use in bi-directional channel tracking, the method comprising:
causing reception, at a first network entity, from a second network entity, information associated with the length of a first frame to be sent by the second network entity to the first network entity;
obtaining, at the first network entity, information associated with the length of a second frame to be sent from the first network entity to the second network entity; and
computing, at the first network entity, a switching point for switching between different channel tracking schemes based on the length of the first frame and the length of the second frame.
